(19) United States
(12) Patent Application Publication
(10) Pub. No.: US 2014/0174430 A1
(43) Pub. Date: Jun. 26, 2014

(54) PYRAMID LAMP MEDALLION CONTROL FOR SOLAR THERMAL POWER GENERATION SYSTEM

(71) Applicants: Brian M. Fitzgerald, Cazenovia, NY (US); John D. Zalewski, Liverpool, NY (US); Peter M. Jacobsen, Oakland, MI (US); Franz Faschinger, Lannach (AT); Richard A. Bakowski, Warners, NY (US); Philipp Ebner, Lannach (AT); David W. Wenthen, Rochester Hills, MI (US); Burke Smith, Romeo, MI (US)

(72) Inventors: Brian M. Fitzgerald, Cazenovia, NY (US); John D. Zalewski, Liverpool, NY (US); Peter M. Jacobsen, Oakland, MI (US); Franz Faschinger, Lannach (AT); Richard A. Bakowski, Warners, NY (US); Philipp Ebner, Lannach (AT); David W. Wenthen, Rochester Hills, MI (US); Burke Smith, Romeo, MI (US)

(21) Appl. No.: 14/072,886

(22) Filed: Nov. 6, 2013

Related U.S. Application Data
(60) Provisional application No. 61/725,562, filed on Nov. 13, 2012.
(60) Provisional application No. 61/725,596, filed on Nov. 13, 2012.
(60) Provisional application No. 61/725,552, filed on Nov. 13, 2012.

(51) Int. Cl. F24J 2/40; G01B 11/26

(52) U.S. Cl. CPC F24J 2/407; G01B 11/26
USPC 126/578; 126/601; 356/138

(57) ABSTRACT

A method of calibrating a mirror orientation system of a heliostat includes mounting an artificial light source to a heliostat mirror, providing an array of light sensors on a solar thermal tower and positioning the heliostat mirror at a first orientation. A control module is provided a signal indicative of a mirror drive mechanism position at the first mirror orientation. The control module correlates the signal indicative of the mechanism position with an energy distribution across the sensor array as the artificial light source is energized when the mirror is at the first orientation. The drive mechanism moves the mirror to a second orientation and directs artificial light on the sensor array. The drive mechanism position signal is correlated with an energy distribution across the sensor array based on the second mirror orientation. The heliostat is calibrated based on the energy distributions and the drive mechanism position signals.

### CROSS-REFERENCE TO RELATED APPLICATIONS

This application claims the benefit of U.S. Provisional Application No. 61/725,562 filed Nov. 13, 2012, U.S. Provisional Application No. 61/725,596 filed Nov. 13, 2012, and U.S. Provisional Application No. 61/725,552 filed Nov. 13, 2012. The entire disclosure of each of the above applications is incorporated herein by reference.

### FIELD

The present disclosure generally relates to solar energy collection and, more particularly, to a system for reliably and cost effectively constructing and calibrating a concentrated solar thermal energy system.

### BACKGROUND

This section provides background information related to the present disclosure which is not necessarily prior art.

Large scale collection of solar energy for use as an alternative power source to the fossil fuel industry has been desired for decades. Several governmental entities across the world have investigated the feasibility of large scale solar energy collection as a power source for public utilities or commercial use. Presently, the most efficient systems for harnessing solar energy and converting the energy into electrical power for general use is through the use of a concentrated solar thermal (CST) power generation system. CST systems rely on concentrated sunlight to generate power. The concentrated sunlight is typically provided from a field of heliostat mirrors that reflect sunlight on a target area of a solar thermal tower. The concentrated solar energy may be converted into electrical energy through a photovoltaic cell, by heating water to create steam that drives a turbine, or any other suitable method. The concentrated solar energy may be stored in a thermal mass and converted to a more user friendly form at a later time.

To generate sufficient power, a CST system may include several hundred or several thousand heliostats spaced apart from one another in a field. Each heliostat includes a mirror that must be accurately positioned to focus the sunlight on the target area of the tower. Due to the rotation of the earth about its axis as well as the rotation of the earth about the sun, and mechanical system tolerances, challenges exist relating to accurately and consistently controlling each heliostat to remain targeted. The efficiency of the solar power generation is directly related to the accuracy to the concentration of the solar energy. For example, it is desirable to maintain an azimuth orientation as well as an elevation orientation within 0.10 degrees of a target position. Misalignment of a mirror or mirrors causes the reflected light to miss the target area thereby reducing the concentration of solar energy. Known mirror heliostats typically track the sun through the use of known solar positions being programmed into each heliostat and the mirror being moved according to the known positions. Due to inaccuracies that may exist in the positioning system of the heliostat mechanism, the actual orientation of the mirror of the heliostat may not be at the desired angular orientation and the reflected sunlight would not be aligned toward the targeted area of the solar power tower. In addition, it may also be a challenge to maintain a desired mirror orientation once it has been initially set.

Typical mirror heliostat devices are very expensive to manufacture and because hundreds or thousands of heliostats are used in a single concentrated solar thermal power generation system, the heliostats constitute the majority of the cost of the solar energy collection system. Known methods for initially installing and targeting the heliostats also contribute to the high cost of starting power generation. For example, many known systems require a predetermined minimum magnitude of sunlight to be reflected from the heliostat mirror to initially target the heliostat. Accordingly, these efforts may only occur during daylight hours when inclement weather is not present. It may take months to initially target each of the heliostats in a given concentrated solar thermal system field.

Additional challenges relate to minimizing the power required to move the heliostat mirror and defining a robust structure sufficient to support the mirror and withstand natural forces such as wind gusts.

Concerns also exist regarding the cost and logistics relating to the control of each heliostat, a power supply to the heliostat positioning system, and the infrastructure required for these systems to properly operate. For example, it may be undesirable to directly wire each heliostat to one another or wire each heliostat to a common power supply or heliostat control unit as the distance between heliostats on the opposite side of a field may be several miles.

### SUMMARY

This section provides a general summary of the disclosure, and is not a comprehensive disclosure of its full scope or all of its features.

A method of calibrating a mirror orientation system of a heliostat includes mounting an artificial light source to a heliostat mirror, providing an array of light sensors on a solar thermal tower and positioning the heliostat mirror at a first orientation. A control module is provided a signal indicative of a mirror drive mechanism position at the first mirror orientation. The control module correlates the signal indicative of the mechanism position with an energy distribution across the sensor array as the artificial light source is energized when the mirror is at the first orientation. The drive mechanism moves the mirror to a second orientation and directs artificial light on the sensor array. The drive mechanism position signal is correlated with an energy distribution across the sensor array based on the second mirror orientation. The heliostat is calibrated based on the energy distributions and the drive mechanism position signals.

The heliostat mirror alignment calibration system includes a heliostat with first and second drive mechanisms for rotating a mirror. An artificial light source is coupled to the mirror such that the artificial light strikes photovoltaic sensors mounted to a solar tower. The sensors output a signal indicative of the intensity of the artificial light. First and second mirror position sensors output signals indicative of the mirror position along first and second axes. A control module correlates a first set of photovoltaic sensor signals with a first set of position sensor signals when the mirror is at a first orientation and correlates a second set of photovoltaic sensor signals with the second set of position sensor signals when the mirror is at a second orientation. The control module calibrates the alignment system based on the photovoltaic sensor signals and the position sensor signals.

A method of calibrating a mirror orientation system of a heliostat includes providing a calibration zone on a solar thermal tower and moving a mirror from the heliostat to a first orientation to reflect solar light on the calibration zone. An energy distribution across the calibration zone is determined based on the first orientation. The mirror is moved to a second orientation. An energy distribution across the calibration zone is determined based on the second mirror orientation. An alignment accuracy of the heliostat is determined based on a comparison on the energy distributions. The heliostat is calibrated to increase the alignment accuracy.

A heliostat mirror positioning system includes a plurality of sensors adapted to be mounted to a solar tower. The sensors provide signals indicative of the solar energy at the respective sensor positions. A central control module is in receipt of the sensor signals and determines an energy distribution associated with a mirror position. A heliostat mirror position sensor provides a signal indicative of the mirror position. The heliostat control module is in receipt of the mirror position signal and is in communication with the central control module is adapted to actuate a drive mechanism to move the mirror to another position. The central control module determines another energy distribution and associates the energy distribution with the new mirror position. The central control module determines an alignment accuracy based on a comparison of the energy distributions and calibrates the positioning system to increase the mirror alignment accuracy.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting a solar thermal heliostat in conjunction with an exemplary solar thermal energy collection system;

FIG. 2 is a fragmentary respective view of a solar heliostat;

FIG. 3 is a fragmentary exploded perspective view of the solar thermal heliostat depicted in FIG. 2;

FIG. 4 is another fragmentary exploded perspective view depicting the remaining portion of the heliostat shown in FIGS. 2-3;

FIG. 5 is a fragmentary sectional view of a portion of the heliostat;

FIG. 6 is a fragmentary sectional view of another portion of the heliostat;

FIG. 7 is a fragmentary sectional view of another portion of the heliostat;

FIG. 8 is a fragmentary sectional view of another portion of the heliostat;

FIG. 9 is a sectional view of a frame and mirror;

FIG. 10 is fragmentary perspective view depicting a puck and a mirror;

FIG. 11 is a schematic depicting a photovoltaic cell battery charging system for a heliostat;

FIG. 12 is a schematic depicting a solar thermal energy collection system including a photovoltaic matrix panel;

FIG. 13 is a flow chart depicting a method of calibrating a heliostat mirror positioning system;

FIG. 14 is a schematic depicting an alternate solar thermal energy collection system including a frusto-conical tower portion including reflective mirrors;

FIG. 15 is a schematic depicting a mirror orientation calibration system;

FIG. 16 is a plan view of a pyramid lamp medallion;

FIG. 17 is a side view of the pyramid lamp medallion; and

FIG. 18 is a flow chart depicting a method of calibrating a mirror orientation system.

Corresponding reference numerals indicate corresponding parts throughout the several views of the drawings.

### DETAILED DESCRIPTION

Example embodiments will now be described more fully with reference to the accompanying drawings.

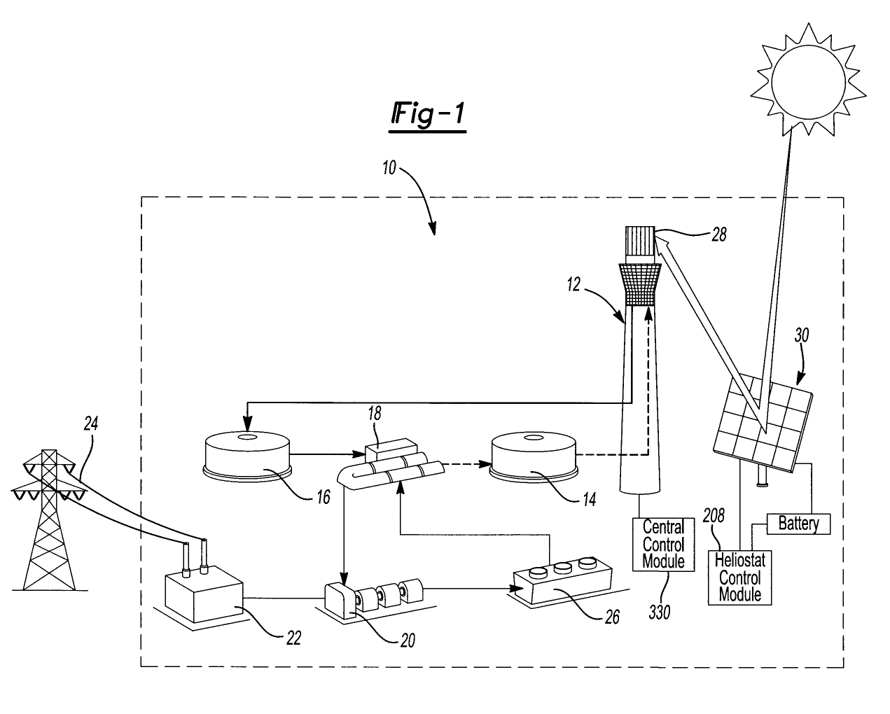

FIG. 1 provides a schematic of an exemplary concentrated solar thermal energy collection system identified at reference numeral 10. System 10 includes a solar thermal tower 12 in fluid communication with a cold fluid storage tank 14 and a heated fluid storage tank 16. Heated fluid storage tank 16 provides energy to a steam generator 18. Steam is provided to a steam turbine and electric generator 20. Electrical energy may be provided to a substation 22 for distribution to a plurality of power lines 24. A cooling tower 26 is in communication with steam generator 18 and steam turbine 20 to return cooled heat transfer fluid to cold storage tank 14. A plurality of heliostats 30 are spaced apart from one another and oriented to reflect sunlight toward a target 28 positioned on solar thermal tower 12.

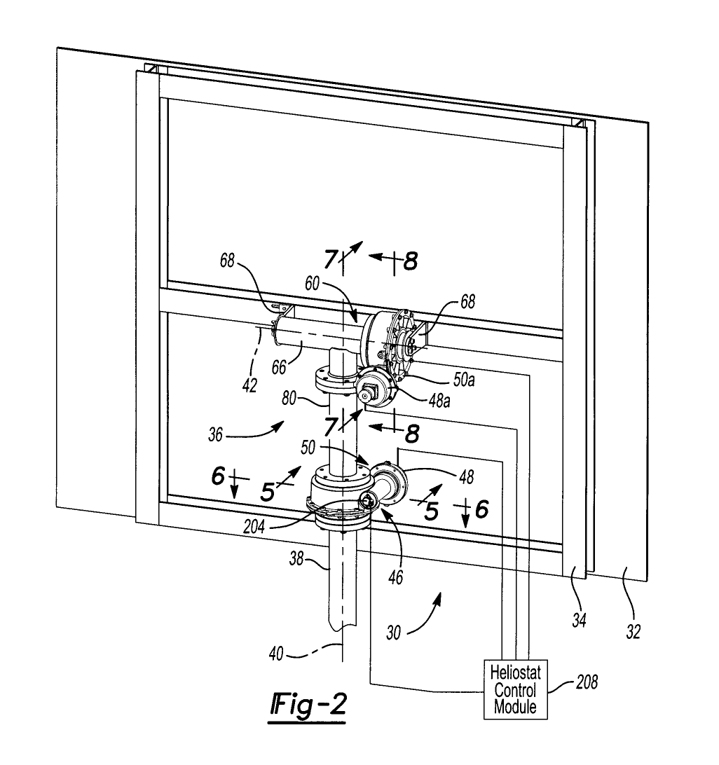

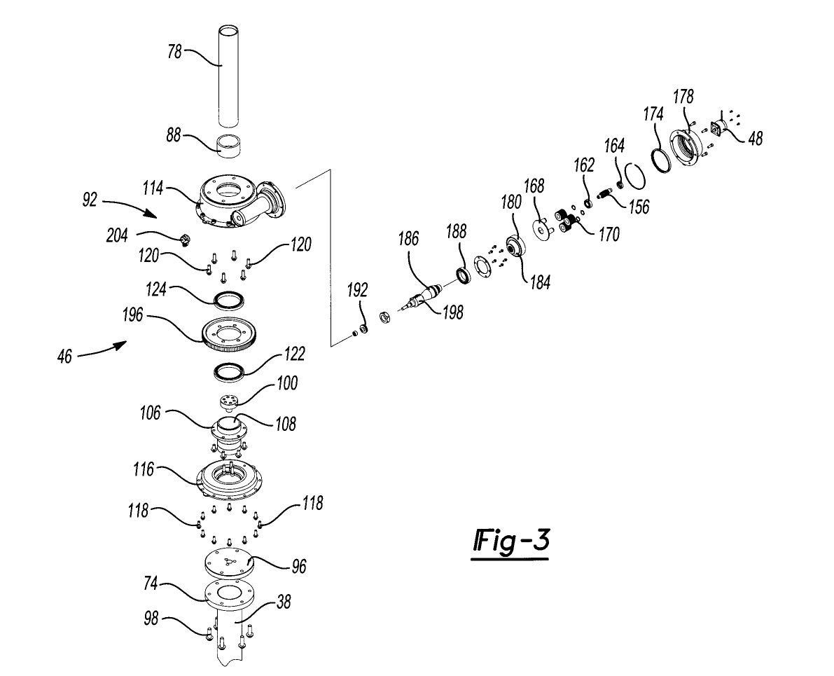

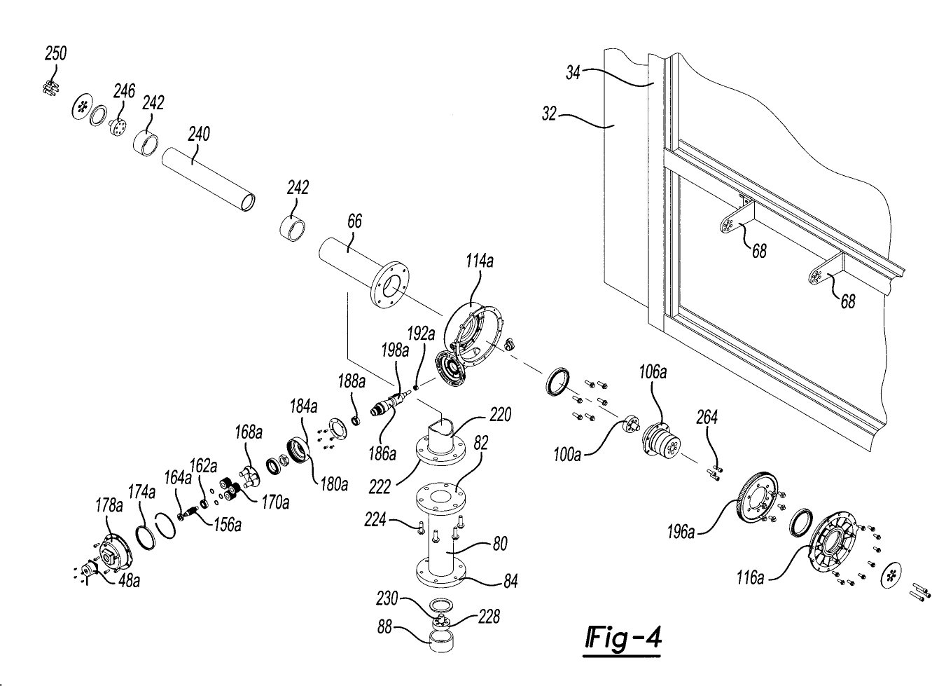

As shown in FIGS. 1-2, each heliostat 30 includes a mirror 32 fixed to a frame 34. A solar tracking mechanism 36 interconnects frame 34 with a post 38 that is fixed to the ground. A guard rail (not shown) or some other easily attainable steel beam may be pile driven into the ground. Post 38 may be fixed to the guard rail. Actuation of tracking mechanism 36 may cause frame 34 to rotate about a first axis 40 and/or a second orthogonal axis 42. More particularly, a first alignment mechanism 46 is operable to rotate frame 34 about first axis 40. First alignment mechanism 46 includes an electric motor 48 and a drivetrain 50 for rotating an outer tube 80 about first axis 40. In similar fashion, a second alignment mechanism 60 is provided to rotate frame 34 about second axis 42. Second alignment mechanism 60 includes an electric motor 48a driving a drivetrain 50a to rotate an outer tube 66 fixed to frame 34 via brackets 68.

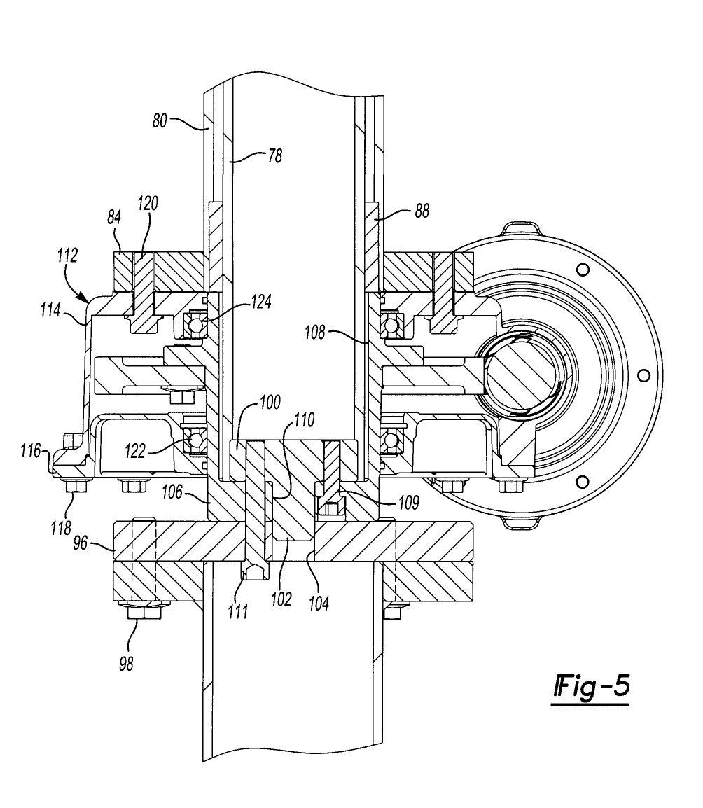

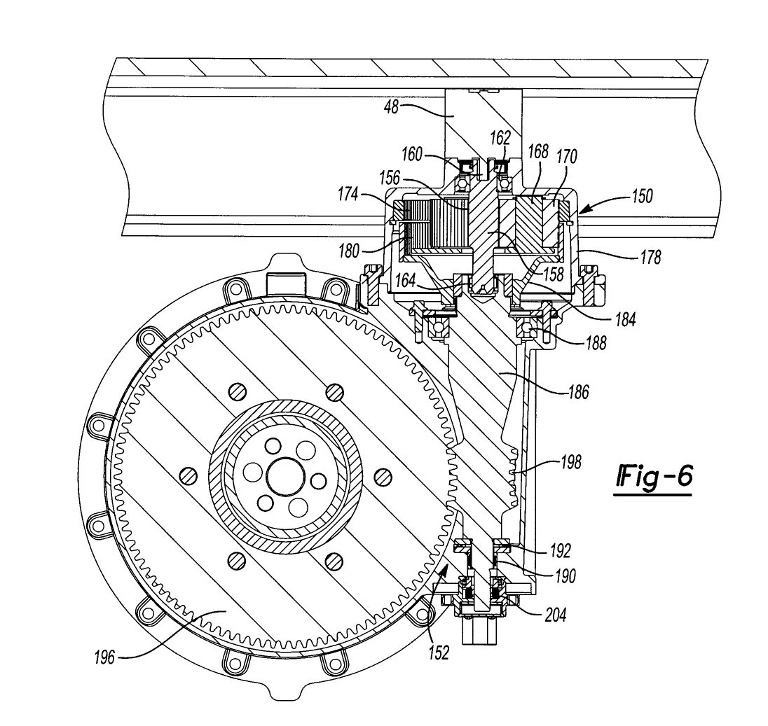

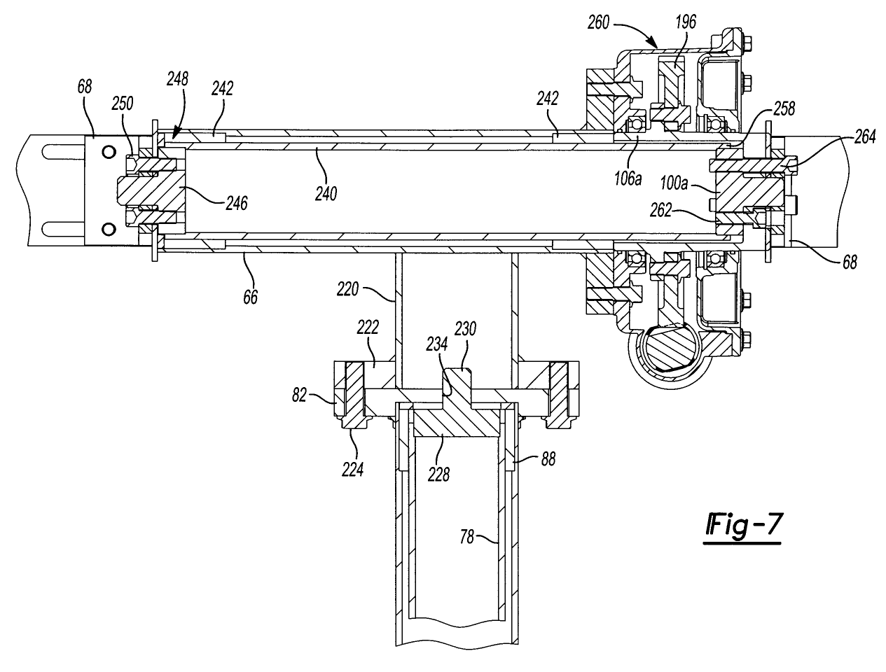

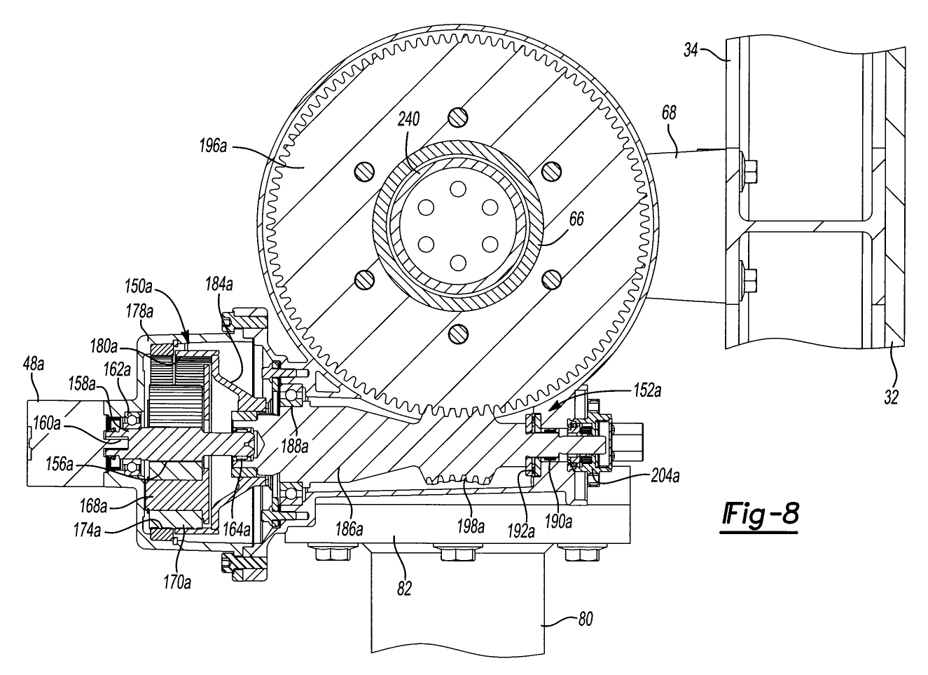

First alignment mechanism 46 is fixed to a flange 74 fixed to post 38. First alignment mechanism 46 includes an inner tube 78 concentrically aligned with outer tube 80. Terminal ends of outer tube 80 are fixed to an upper flange 82 and a lower flange 84. Bushings or bearings 88 concentrically align inner tube 78 with outer tube 80 and allow relative rotation therebetween. First alignment mechanism 46 includes a first actuator 92 operable to rotate outer tube 80 relative to inner tube 78. A plate 96 is fixed to flange 74 via a plurality of fasteners 98. A coupling 106 abuts plate 96 and includes a pocket 108 in receipt of inner tube 78. An adapter 100 is press fit within a counterbore formed within one end of inner tube 78 and positioned within pocket 108. A plurality of fasteners 109 fix coupling 106 to adapter 100. Fasteners 111 (FIG. 5) fix plate 96 to adapter 100. Adapter 100 includes a pin 102 extending through an aperture 104 of plate 96. Pin 102 extends through an aperture 110 of coupling 106 to align outer tube 80 and inner tube 78 with post 38.

First actuator 92 includes a housing assembly 112 including a first half 114 fixed to a second half 116 by a plurality of fasteners 118. Electric motor 48 and drivetrain 50 are positioned within housing 112. Housing 112 is rotatably supported on coupling 106 by a pair of bearings 122, 124. Based on this arrangement, post 38 remains non-rotatably fixed to the ground during operation of heliostat 30. Plate 96, adapter 100 and coupling 106 remain fixed to post 38. Fasteners 120 fix housing 112 to flange 84, housing 112, flange 82, outer tube 80 and flange 84 to rotate as a unit relative to post 38 during energization of first actuator 92.

First actuator 92 includes electric motor 48 and drivetrain 50 positioned within housing 112. Drivetrain 50 includes a primary gear reducer 150 configured as a two-stage compound-coupled epicyclical planetary gearset driving a worm and gear final drive set 152. Planetary gearset 150 includes a sun gear 156 integrally formed on an input shaft 158 that is fixed for rotation with an output shaft 160 of electric motor 48. Input shaft 158 is supported for rotation by a roller bearing 162 and a needle bearing 164. Planetary gearset 150 includes a carrier 168 rotatably supporting a plurality of circumferentially spaced apart pinion gears 170. A first ring gear 174 is fixed to an end cap 178 forming a portion of housing 112. Each of pinion gears 170 are in constant meshed engagement with first ring gear 174 and sun gear 156. A second ring gear 180 is positioned adjacent to first ring gear 174 and in constant meshed engagement with each of pinion gears 170. Second ring gear 180 includes one to three more internal teeth than first ring gear 174. Second ring gear 180 functions as the output of planetary gearset 150. It is contemplated that planetary gearset 150 provides a reduction ratio of greater than 200:1. A yoke 184 is fixed for rotation with second ring gear 180.

Worm and gear final drive set 152 includes a worm shaft 186 having an enveloping worm gear 198 formed thereon. Worm shaft 186 is supported for rotation in housing 112 by a bearing 188 and another bearing 190. A thrust bearing or thrust washer 192 is provided to react the axial load applied to worm shaft 186. A cylindrical gear 196 is in constant meshed engagement with worm gear 198. The worm and gear final drive set 152 is configured to provide a final drive gear ratio of approximately 101:1. The combination of two-stage compound planetary gearset 150 and worm and gear final drive set 152 provides a total reduction ratio of greater than 20,000:1 with the least number of gear components thereby minimizing the necessary system input torque and power consumption.

Cylindrical gear 196 may be helical or spur if the thread lead angle of worm gear 198 is less than (4 degrees) without reducing the contact area between members significantly. The worm and gear final drive set 152 backlash and consequent axis rotation accuracy is controlled by the worm shaft and cylindrical final drive gear center distance and circular tooth thickness of both members. The use of cylindrical gear 196 with the enveloping worm gear 198 allows for the production of components within a strict tooth size tolerance (DIN 8 size tolerance) categorized into grades with composite roll inspection within the size range, selected and matched based on the measured center distance of the housing. The cylindrical gear can be laced through the body of the worm thread form at assembly for rapid production.

An encoder 204 is associated with worm shaft 186 to output a signal indicative of the position of mirror 32 along first axis of rotation 40. Encoder 204 may be a rather inexpensive and durable hall-type magnetic rotary encoder. The 101:1 final drive ratio permits the use of such an encoder, while still meeting the required targeting accuracy.

A heliostat control unit 208 is in receipt of the encoder signal and determines the angular position of mirror 32 on first axis 40 based on the signal and the geometrical relationship between worm gear 198 and gear 196. Heliostat control unit is also in communication with electric motor 48 to selectively energize the motor and rotate mirror 32. It should be appreciated that the enveloping worm and gear final drive set 152 is constructed such that a torque input applied to gear 196 will not rotate worm shaft 186. In other words, the worm and gear final drive set 152 may not be back driven. As such, first actuator 92 may be beneficially used to maintain the orientation of mirror 32 at a desired location once first alignment mechanism 46 has rotated frame 34 and mirror 32 to a desired angular position as determined by heliostat control unit.

Gear 196 includes teeth shaped as standard cylindrical or spur gear teeth while worm gear 198 is enveloping and also includes teeth having a helical lead angle less than or equal to four degrees. The intentional mismatch of a spur gear to a helical gear-shape eliminates backlash within the gearset to assure an increased positional accuracy and minimal change in mirror position once the angular orientation of the mirror has been set.

Second alignment mechanism 60 of heliostat 30 includes a vertically oriented stub shaft 220 having one end welded to a flange 222 and an opposite end fixed to outer tube 66. Flange 222 is rigidly mounted to flange 82 by a plurality of fasteners 224. An adapter 228 is fixed to an inner tube 240 and includes a pin portion 230 protruding through an aperture 234 extending through flange 82.

Second alignment mechanism 60 functions substantially similarly to first alignment mechanism 46 with the exception that outer tube 66 remains fixed while inner tube 240 may be rotated to change the angular position of mirror 32. Bushings 242 concentrically align outer tube 66 with inner tube 240 and allow relative rotation therebetween. An adapter 246 is fixed to an end 248 of inner tube 240. Fasteners 250 fix one of brackets 68 with adapter 246 such that bracket 68 rotates with inner tube 240.

Second actuator 260 is substantially the same as first actuator 92. As such, similar elements will be identified with like reference numerals including an “a” suffix. Coupling 106a is fixed to adapter 100a with a plurality of fasteners 262. Adapter 100a is fixed to an opposite end 258 of inner tube 240. A second actuator 260 is operable to rotate inner tube 240 about second axis 42. Fasteners 264 fix adapter 100a to the other bracket 68. Energization of electric motor 48a causes rotation of inner tube 240 relative to outer tube 66. Brackets 68, frame 34 and mirror 32 are rotated about second axis 42.

Heliostat control unit is in receipt of a signal from encoder 204a indicative of the angular position of mirror 32 along second axis 42 Heliostat control unit is operable to determine a target angular position for mirror 32 in relation to first axis 40 and second axis 42. To conserve energy, heliostat control unit implements an incremental target positioning scheme as opposed to a continuous control. A frequency of incremental target positioning is based on the particular position of each mirror 32 in the heliostat field in relation to the target, the backlash of the drive mechanism, and the amount of energy available per unit time for actuator operation. Heliostat control unit may also be programmed to position mirror 32 at an initial leading position where the reflected light may be less than optimally targeted but as the time of day changes, the reflection becomes targeted at a nominal position. A tolerance regarding a maximum trailing position may also be programmed within heliostat control unit to allow the reflected rays to be less than optimally targeted for an amount of time as the time of day continues past the time at which the reflection was targeted to nominal. It is contemplated that electric motors 48, 48a are DC stepping motors. Heliostat control unit 208 implements intermittent pulse operation with solid state circuitry to minimize the total power required to properly align mirror 32.

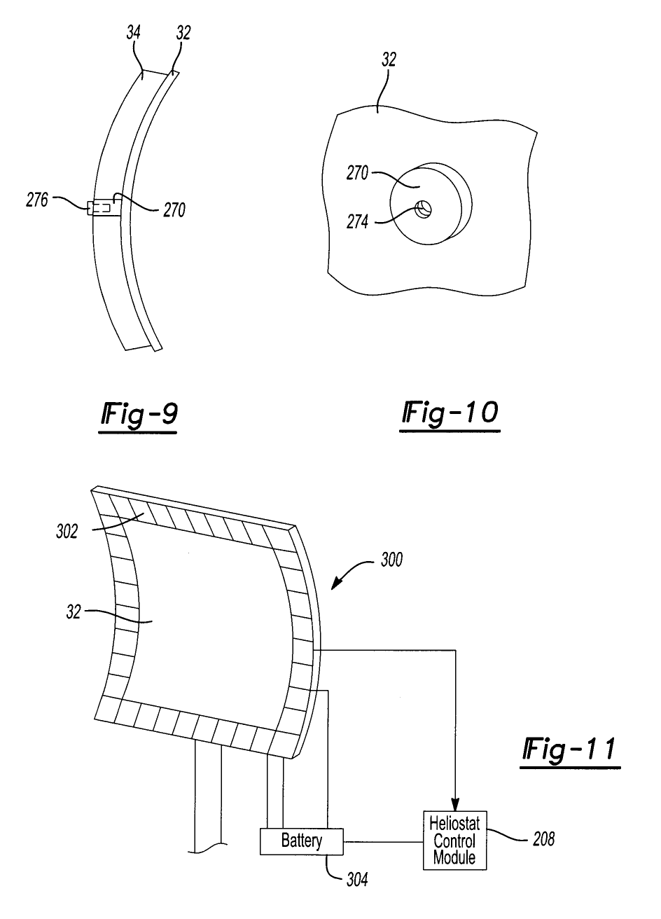

Mirror 32 is a single-piece monolithic mirror constructed from low iron grade glass with a metallic plating for maximum reflectivity. As shown in FIGS. 9 and 10, frame 34 may include a parabolic concave shape. Mirror 32 is adhesive mounted to the parabolically shaped support frame 34 such that the mirror also defines a parabolic concave shape within the flexibility limits of the glass. This arrangement reduces the deflection losses of the solar light beam from flatness irregularities that may be imparted due to the glass tempering heat treatment process.

An optional center anchor 270 may be used to couple the mirror to the frame. It is contemplated that mirror 32 will be unloaded from shipping dunnage and handled throughout the assembly process with robotic automation using vacuum and pneumatic powered contact devices. The plated surface of the mirror and the face of support frame 34 will be coated with an adhesive bonding compound. Center anchor 270 may be constructed from an elastomeric material including a threaded insert 274. Center anchor 270 may be heated prior to assembly to accelerate the curing of the bonding adhesive upon placement at the rear center of the mirror. Mirror 32 may be positioned adjacent parabolic frame 34 and overflexed to assure that the center portion of the mirror contacts the frame during initial placement. Mirror 32 is aligned to frame 34 and pressed into final position. Anchor 270 is clamped to frame 34 using a threaded fastener 276 and the mirror to frame adhesive is allowed to cure. Alternative fastening techniques including the use of rivets, snap rings and other coupling devices are contemplated as being within the scope of the present disclosure.

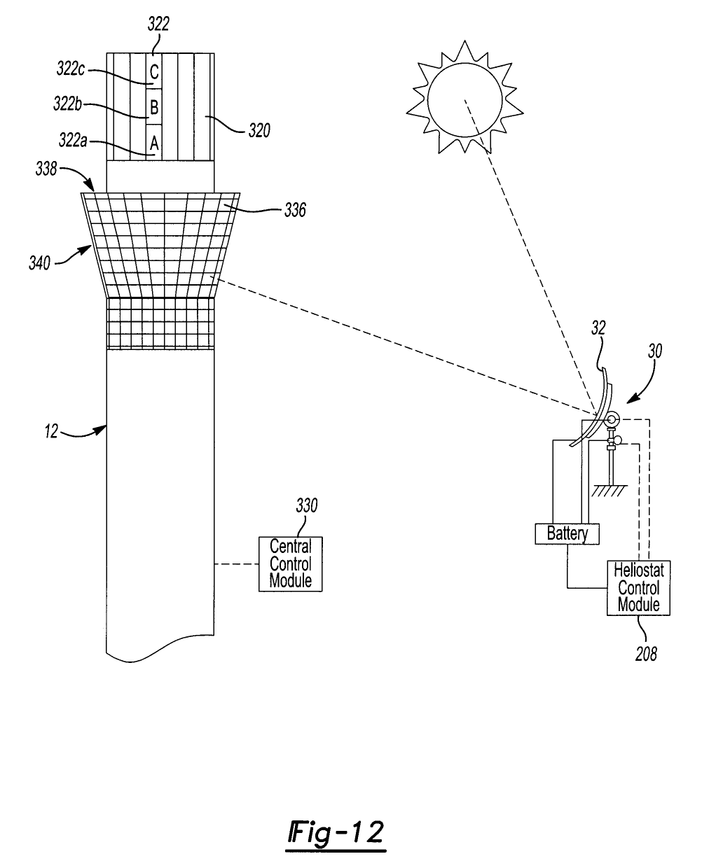

As best depicted in FIG. 11, a photovoltaic energy storage system 300 includes a plurality of photovoltaic cells 302 positioned about the perimeter of mirror 32. Photovoltaic cells 302 provide electrical current to a battery 304 when sunlight strikes photovoltaic cells 302. Battery 304 may be electrically coupled to heliostat control unit to provide energy for a full range of daily operations as well as emergency positioning of mirror 32 during night time hours. Energy from battery 304 may be used to power electric motors 48, 48a as well as heliostat control unit. Should it be necessary to return mirror 32 to a home position, it may be desirable to use ambient light energy at dawn or dusk to perform this manoeuver using electrical energy from photovoltaic cells 302. The battery backup power may be used for low energy heliostat control unit operations and night time maintenance commands if necessary.

As stated previously, to assure efficient operation of solar thermal energy collection system 10, it is important to accurately orient each of the mirrors 32 associated with each of the heliostats 30 positioned within a given solar collection field. In particular, it may be desirable to orient several mirrors 32 to a particular target zone of a solar collector 320 mounted on solar thermal tower 12, as shown in FIG. 12. Solar collector 320 is the portion of tower 12 at which solar energy is transferred to the fluid flowing through tower 12 and subsequently into the heated storage tank 16 as depicted in FIG. 1. For example, solar collector 320 may be partitioned into a number of portions circumferentially positioned about tower 12. One such partition is identified with the reference numeral 322. Partition 322 may be further subdivided into any number of vertically stacked zones such as 322C, 322B or 322A. A central control module 330 determines which heliostat mirrors should be targeted with which solar collector zone to best transfer energy to the fluid medium without overheating certain zones of the solar collector.

A mirror positioning and calibration system may be used to determine the mirror alignment accuracy and recalibrate the mirror positioning system to increase the alignment accuracy. In one example, a plurality of photovoltaic cells 336 are positioned about the circumference of another portion of tower 12 in a predetermined array. Photovoltaic sensors 336 are positioned on a frusto-conically shaped portion 338 of tower 12. The cone is pointed toward the ground such that solar light reflected from mirrors 32 is received at an angle of incidence being substantially zero degrees. Stated another way, the solar light approaches the surface of the sensors 336 at substantially ninety degrees. This relative orientation may be beneficial to minimize the amount of energy reflected off of the surfaces of sensors 336.

Each photovoltaic sensor 336 outputs a signal indicative of the amount of solar energy received. Signals from sensors 336 are provided to central control module 330. Sensors 336 are positioned on a portion of tower 12 identified as a calibration zone 340 wherein several photovoltaic sensors 336 are positioned in an array. Central control module 330 may determine an energy distribution across the calibration zone. As will be described in detail, it is contemplated that each heliostat may be evaluated for alignment accuracy by orienting the mirror 32 to reflect solar light toward a particular calibration zone containing several photovoltaic sensors 336. After alignment calibration is completed, mirror 32 of the recalibrated heliostat 30 will be directed to an appropriate zone of solar collector 320 to store solar energy.

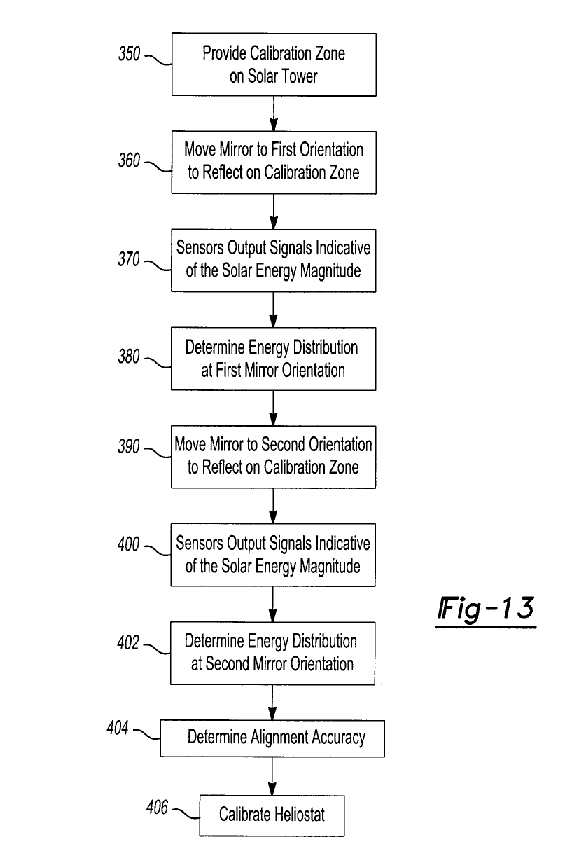

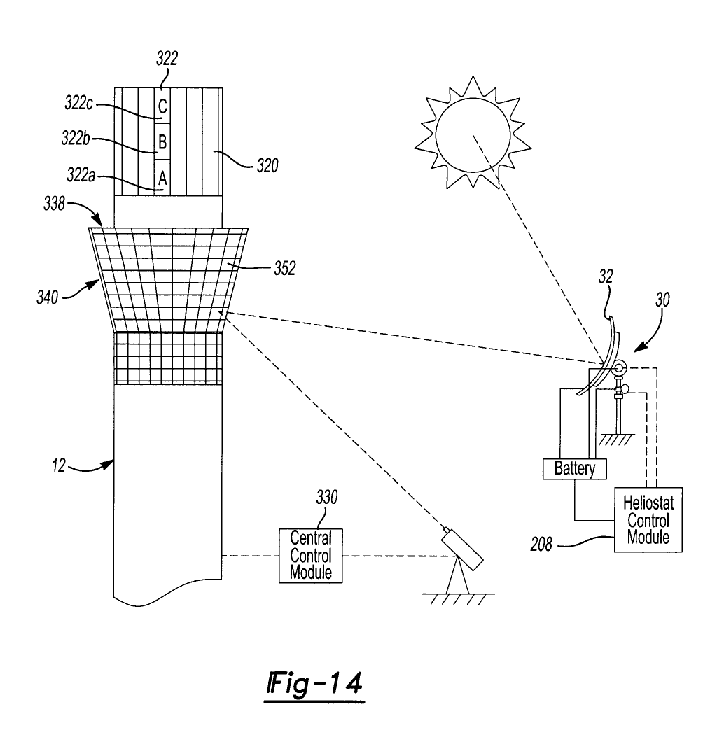

With reference to FIG. 13, a flow chart depicting a method of calibrating a mirror orientation system of a heliostat is provided. At block 350, calibration zone 340 is provided on solar tower 12. Calibration zone 340 may include the photovoltaic sensors 336 previously described or may include a plurality of reflective mirrors 352, as shown in FIG. 14. Cameras 354 may function as sensors and may be mounted on the ground in communication with central control module 330. Cameras or other sensors 354 are configured to output signals indicative of the energy reflected from a certain area within the calibration zone.

At block 360, central control module 330 instructs heliostat control module 208 to move to a first orientation to reflect solar light on the calibration zone. At block 370, sensors 336 or camera 354 output signals indicative of the magnitude of solar energy acting upon the individual sensor. In the instance of the sensor being a camera, camera 354 may be operable to output a signal indicative of several different solar energy magnitudes within the camera's field of view.

At block 380, central control module 330 determines an energy distribution across the calibration zone based on the first mirror orientation. At block 390, central control module 330 instructs heliostat control module 208 to move mirror 32 to a second orientation where solar light continues to be reflected on the calibration zone. It is contemplated that the second orientation of mirror 32 is very similar to the first orientation of mirror 32 since it may be desirable to obtain a targeting accuracy of 0.10 degrees or less. As such, the amount of mirror movement between the first and second orientations may be relatively small. During the calibration procedure, it may be desirable to energize only one of motors 48, 48A at a time and subsequently both motors 48 and 48A simultaneously.

At block 400, sensors 336 and/or camera 354 output signals indicative of the solar energy magnitude at the sensor location. At block 402, central control module 330 determines the energy distribution across the calibration zone at the second mirror orientation. At block 404, central control module 330 determines an alignment accuracy of heliostat 30 based on a comparison of the energy distributions. At block 406, central control module 330 associates each energy distribution with its corresponding mirror orientation to calibrate the heliostat to maintain or increase the alignment accuracy of the mirror orientation system. This sequence may be repeated over time (hours, days, weeks, or month) at various heliostat positions throughout the entire range of operation. The accuracy and reliability of the heliostat may be determined and used as a periodic maintenance and monitoring system. Periodic recalibration will detect movements of the heliostat due to the environment (landscape and weather) or collisions from maintenance equipment or such. It should be appreciated that cameras 354 may also be used to measure the surface temperature and light density about the solar collector 320.

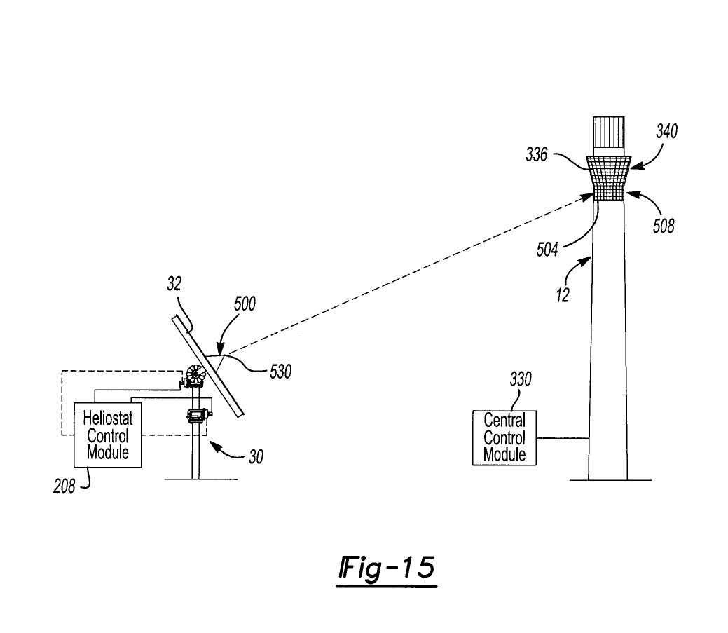

FIG. 15 is a schematic depicting a pyramid lamp medallion 500 mounted to heliostat 30. During initial installation and calibration of the possibly several hundred or thousand heliostats in a solar thermal energy collection system, it may be useful to temporarily couple a device such as pyramid lamp medallion 500 to mirror 32 of a given heliostat 30. Pyramid lamp medallion 500 simulates the reflective solar beam centroid of mirror 32 by emitting one or more laser light signals from various locations on the pyramid lamp medallion. An initial alignment of mirror 32 as well as post-installation calibration may be performed at night or during overcast days when solar light is not available for use. Furthermore, the laser light source of each pyramid lamp medallion may be independently momentarily energized to assure that a single particular heliostat 30 within the field is being calibrated and that the solar light from another heliostat is not affecting the calibration.

It may be desirable to wrap a plurality of photovoltaic sensors 504 about a portion of solar thermal tower 12 to function as receptors of the laser light. It should be appreciated that photovoltaic sensors 336, previously described, may not exhibit sufficient sensitivity to excitation by laser light as they are designed to receive concentrated solar light. As such, it is contemplated that an array 508 of photovoltaic sensors 504 is positioned adjacent to or in lieu of array 340. If calibration is only to occur using laser light source, the array 340 may be eliminated or replaced with photovoltaic sensors 504 that are operable to output a signal indicative of the intensity of laser light acting thereon.

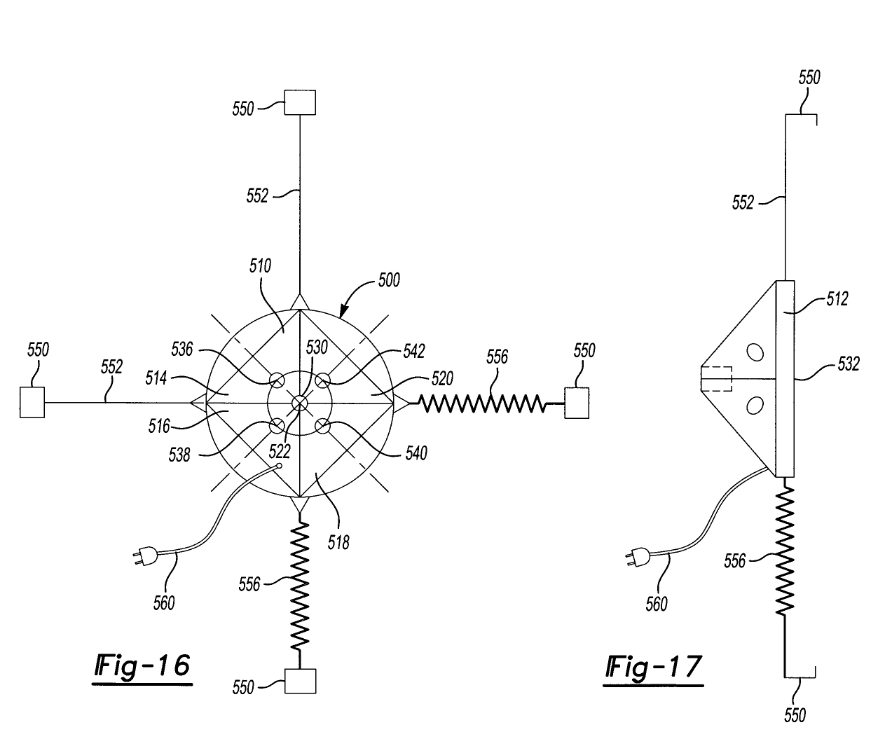

As shown in FIGS. 16-17, each pyramid lamp medallion includes a regular polyhedron 510 such as a tetrahedron, pentahedron or hexahedron to define base 512. In the embodiment depicted in FIGS. 16-17, a regular tetrahedron includes angled sides 514, 516, 518, and 520 intersecting at a point 522. Pyramid lamp medallion 500 includes a plurality laser light sources individually energizeable to emit light. A central light source 530 is positioned where point 522 would be located and is oriented to emit light along an axis perpendicular to a surface 532 of a tetrahedral, pentahedral or hexahedral base 512. A second light source 536 is positioned on or beneath surface 514 to emit light along an axis extending substantially perpendicular to surface 514. A third light source 538 is mounted on or extends through surface 516. The light emitted from third light source 538 extends along an axis substantially perpendicular to surface 516. A fourth light source 540 and a fifth light source 542 are similarly associated and oriented relative to surfaces 518 and 520, respectively.

To facilitate simple installation and removal of pyramid lamp medallion 500 to and from heliostat 30, a plurality of anchors 550 are used to attach the pyramid lamp medallion to mirror 32. In particular, it is contemplated that anchors 550 are configured as clips or hooks to engage an edge of mirror 30. Cables 552, having a predetermined length, include one end fixed to anchors 550. An opposite end of each cable 552 is fixed to base 512. Springs 556 interconnect two of the other anchors 550 with base 512. Each of the anchors 550 are circumferentially spaced apart from one another approximately ninety degrees. By positioning anchors 550 in this manner, centralized first light source 530 will be coaxially aligned with the reflected solar beam centroid of mirror 32.

Laser light sources 530, 536, 538, 540, 542 may receive power via an electrical cord 560 that may be coupled to a source of power such as battery 304 depicted in FIG. 11. Any other alternate source of energy may also be used. For example, an easily transportable energy storage device such as a relatively small battery may be electrically coupled to cord 560 to energize the laser light sources. Each of the light sources may be individually energized or all of the light sources may be simultaneously energized depending on the calibration routine being implemented.

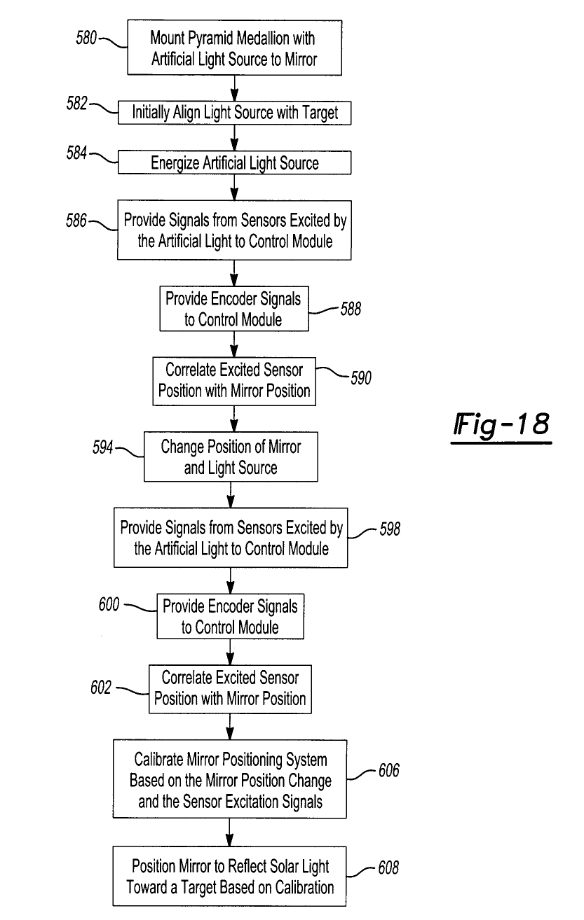

FIG. 18 provides a flow chart describing an exemplary heliostat targeting calibration system. At block 580, pyramid lamp medallion 500 is mounted to mirror 32 of heliostat 30 as previously described. Anchors 550 may be attached to mirror 32 to temporarily mount pyramid lamp medallion 500 to mirror 32 at a position where central light source 530 is aligned with the reflected solar beam centroid of the mirror. At block 582, central light source 530 is initially and coarsely aligned with a target zone on photovoltaic sensor array 508. The coarse alignment may be accomplished using a hand-held sighting system that may or may not include a laser light source.

At block 584, one or more of the pyramid lamp medallion light sources is energized. It is contemplated that central control module 330 instructs heliostat control module 208 to illuminate one or more of the pyramid lamp medallion light sources. Pyramid lamp medallion 500 may be placed in communication with heliostat control module 208 through wireless communication or a direct electrical connection. As light emitted from one or more of the pyramid lamp medallion light sources strikes one or more of the photovoltaic sensors 504, signals are emitted from the sensor to central control module 330 at block 586. At block 588, signals from encoders 204, 204a are provided to central control module 330. The positions of the photovoltaic sensors 504 exhibiting excitation as evidenced by the signals emitted therefrom are correlated to the position of mirror 32 as indicated by the encoder signals at block 590.

At block 594, central control module 330 instructs heliostat control module 208 to move mirror 32 and pyramid lamp medallion 500 to another position. To calibrate the mirror positioning system, it may be desirable to rotate mirror 32 such that a different artificial light source from pyramid lamp medallion strikes a target zone of photovoltaic sensor array 508. The steps of providing signals from a sensor excited by the artificial light to the control module, providing encoder signals to the control module that represent the current position of mirror 32, and correlating the excited sensor positions with the present mirror position are repeated at blocks 598, 600 and 602. This routine may be repeated several times to cause the various other pyramid lamp medallion light sources to become aligned with the target zone on an array 508. The central control module 330 may incorporate the known geometric relationship between central light source 530 and second through fifth light sources 536, 538, 540, 542 to increase the alignment accuracy and further calibrate the mirror positioning system. At block 606, control calibrates the mirror positioning system based on the various sensor excitation signals and mirror position signals previously obtained. At block 608, central control module 330 may instruct heliostat control module 208 to move mirror 32 to reflect solar light toward target 28 on solar thermal tower 12 to begin energy storage once the solar light is provided.

During an initial alignment phase of constructing solar thermal energy collection system 10, it is envisioned that several pyramid lamp medallions 500 will be simultaneously installed on heliostats 30 spaced apart from one another in a given field. Central control module 330 is operable to instruct several different heliostat control modules 208 and simultaneously or sequentially illuminate artificial light sources from different pyramid lamp medallions. Wireless communication will maintain dialogue between each heliostat module 208 and central control module 330 to update and maintain operating algorithms for each heliostat. In one example, central control module 330 requests a light signal from a specific medallion that will flash a momentary beam to detect position accuracy. Once the signal is recorded, central control module 330 will proceed with another heliostat position recording. This process may be reiterated through several position trials with multiple light sources on a given pyramid lamp medallion until a desired accuracy and repeatability is established.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of calibrating a mirror orientation system of a heliostat, the method comprising:
mounting an artificial light source to a heliostat mirror;
providing an array of light sensors on a solar thermal tower;
positioning the heliostat mirror at a first orientation;
providing a control module a signal indicative of a mirror drive mechanism position at the first mirror orientation;
energizing the artificial light source to strike the sensor array;
correlating the signal indicative of the drive mechanism position with an energy distribution across the sensor array based on the first orientation;
instructing a drive mechanism to move the mirror a predetermined amount to a second orientation and direct artificial light on the sensor array;
providing the control module a signal indicative of the drive mechanism position at the second mirror orientation;
correlating the drive mechanism position signal with an energy distribution across the sensor array based on the second mirror orientation; and
calibrating the heliostat to increase an alignment accuracy of the heliostat based on the energy distributions and the drive mechanism position signals.

2. The method of claim 1, wherein the artificial light source is emitted from a pyramid light medallion temporarily coupled to the heliostat mirror.

3. The method of claim 2, further including aligning the artificial light source with a solar beam centroid of the mirror.

4. The method of claim 2, wherein additional artificial light sources are emitted from the pyramid lamp medallion, the light sources being aligned along different axes.

5. The method of claim 4, wherein one of the additional light sources is directed toward the sensor array when the mirror is at the second orientation.

6. The method of claim 5, wherein the pyramid lamp medallion includes a regular polyhedral shape.

7. The method of claim 6, wherein at least one of the additional light sources includes a laser light source extending substantially perpendicular to a face of the polyhedral shape.

8. The method of claim 1, wherein the array of light sensors is shaped as a ring encompassing the tower.

9. The method of claim 1, wherein providing a signal indicative of a mirror drive mechanism position includes providing an encoder signal indicating a position of a rotatable shaft of the mirror drive mechanism.

10. The method of claim 9, further including providing another encoder signal indicating a position of another rotatable shaft of the mirror drive mechanism, wherein the encoder signal relates to a mirror elevation position and the another encoder signal relates to a mirror azimuth position.

11. A heliostat mirror alignment calibration system, comprising:
a heliostat including a first drive mechanism rotating a mirror about a first axis and a second drive mechanism rotating the mirror about a second axis extending perpendicular to the first axis;
an artificial light source adapted to be coupled to the heliostat mirror;
photovoltaic sensors adapted to be mounted to a solar tower, the sensors outputting signals indicative of the intensity of artificial light striking the sensor;
first and second mirror position sensors operable to output signals indicative of the mirror position along the first and second axes;
a control module in receipt of the photovoltaic sensor signals and the position sensor signals, the control module correlating a first set of photovoltaic sensor signals with a first set of position sensor signals when the mirror is at a first orientation, the control module correlating a second set of photovoltaic sensor signals with a second set of position sensor signals when the mirror is at a second orientation and calibrating the heliostat alignment system based on the photovoltaic sensor signals and the position sensor signals.

12. The heliostat mirror alignment calibration system of claim 11, wherein the artificial light source is coupled to a pyramid lamp medallion including a regular polyhedral shape.

13. The heliostat mirror alignment calibration system of claim 12, wherein the artificial light source includes a laser aligned with a solar beam centroid of the mirror.

14. The heliostat mirror alignment calibration system of claim 13, further including additional artificial light sources coupled to the pyramid lamp medallion, at least one of the additional light sources being emitted substantially perpendicular to a face of the polyhedral shape.

15. The heliostat mirror alignment calibration system of claim 11, further including a heliostat control module being in electrical communication with the position sensors, the heliostat control module being in wireless communication with the control module.

16. The heliostat mirror alignment calibration system of claim 11, wherein the photovoltaic sensors are arranged as a ring encompassing the solar tower.

17. The heliostat mirror alignment calibration system of claim 11, wherein the first position sensor includes an encoder coupled to a rotatable shaft within the first drive mechanism.

18. The heliostat mirror alignment calibration system of claim 17, wherein the second position sensor includes an encoder coupled to a rotatable shaft within the second drive mechanism.

19. A method of calibrating a mirror orientation system of a heliostat, the method comprising:
providing a calibration zone on a solar thermal tower;
moving a mirror of a heliostat to a first orientation to reflect solar light on a calibration zone;
determining an energy distribution across the calibration zone based on the first orientation;
moving the mirror a predetermined amount to a second orientation to reflect solar light on the calibration zone;
determining an energy distribution across the calibration zone based on the second mirror orientation;
determining an alignment accuracy of the heliostat based on a comparison of the energy distributions; and
calibrating the heliostat to increase the alignment accuracy.

20. The method of claim 19, further including mounting an array of photovoltaic sensors to the solar tower at the calibration zone, each sensor outputting a signal indicative of the magnitude of solar energy at the sensor position.

21. The method of claim 20, further including mounting a solar collector on the tower further from the ground than the sensor array.

22. The method of claim 21, further including moving the mirror to reflect solar light toward the collector after the calibration has been completed.

23. The method of claim 20, wherein the photovoltaic sensors are mounted at an angle less than ninety degrees relative to the ground such that solar light reflected from the mirror strikes the sensors at an incidence angle of substantially zero degrees.

24. The method of claim 19, wherein the distribution determination is made by a central processor and the mirror moving is controlled by a heliostat control unit mounted to the heliostat, the heliostat control unit wirelessly communicating with the central processor.

25. The method of claim 24, further including positioning a plurality of photovoltaic cells adjacent the mirror, the photovoltaic cells providing energy to the heliostat control unit, and providing a drive mechanism to position the mirror, the drive mechanism being supplied electrical energy from the photovoltaic cells.

26. A heliostat mirror positioning system, comprising:
a plurality of sensors adapted to be mounted to a solar tower about its circumference, the sensors being in receipt of solar light reflected by a heliostat mirror and providing signals indicative of the solar energy at the respective sensor positions;
a central control module in receipt of the signals provided by the sensors, the control module determining an energy distribution associated with a mirror position;
a heliostat mirror position sensor providing a signal indicative of the mirror position;
a heliostat control module in receipt of the mirror position signal and being in communication with the central control module to associate the energy distribution with the mirror position, the heliostat control module being adapted to actuate a drive mechanism, wherein the central control module commands the heliostat control module to move the mirror to another position, determines another energy distribution, and associates another energy distribution with the another mirror position, the central control module determining an alignment accuracy based on a comparison of the energy distributions, and calibrating the positioning system to increase the mirror alignment accuracy.

27. The mirror positioning system of claim 26, wherein the central control module and the heliostat control module communicate via a wireless signal transmission.

28. The mirror positioning system of claim 26, wherein the sensors include photovoltaic sensors, and, wherein the photovoltaic sensors are mounted at an angle less than ninety degrees relative to the ground such that solar light reflected from the mirror strikes the sensors at an incidence angle of substantially zero degrees.

29. The mirror positioning system of claim 28, wherein the photovoltaic sensors are adapted to be mounted to the solar tower at positions closer to the ground than a solar collector.

30. The mirror positioning system of claim 26, further including a plurality of photovoltaic cells adapted to be mounted adjacent to the mirror, the photovoltaic cells providing electrical energy to the heliostat mirror position sensor.

31. The mirror positioning system of claim 30, wherein the photovoltaic cells provide energy to the heliostat control module.

32. The mirror positioning system of claim 26, wherein the central control module determines a time duration to energize the drive mechanism to incrementally re-position the mirror, as the time of day changes.

33. The mirror positioning system of claim 32, wherein the central control module determines an adjusted position of the mirror to be initially misaligned to increase an amount of time between re-positioning energizations, the mirror being properly aligned after the earth rotates a predetermined amount.
